(19) United States
(12) Patent Application Publication
(10) Pub. No.: US 2024/0001331 A1
(43) Pub. Date: Jan. 4, 2024

(54) LITHIUM MANGANESE OXIDE SPINEL SORBENT COMPOUNDS AND METHODS OF SYNTHESIS

(71) Applicant: E3 LITHIUM LTD., Calgary (CA)

(72) Inventors: Rowan JASTRZEBSKA, Calgary (CA); Munish SHARMA, Calgary (CA)

(21) Appl. No.: 18/039,329

(22) PCT Filed: Dec. 10, 2021
(86) PCT No.: PCT/CA2021/051782

§ 371 Date: May 30, 2023

Related U.S. Application Data
(60) Provisional application No. 63/124,506, filed on Dec. 11, 2020.

(51) Int. Cl. B01J 20/04; B01J 20/28; B01J 20/30; B01J 20/34

(52) U.S. Cl. CPC B01J 20/041; B01J 20/28004; B01J 20/3021; B01J 20/3078; B01J 20/3085; B01J 20/3433; B01J 20/3475; B01J 2220/4806

(57) ABSTRACT

Sorbent compounds useful in the extraction of lithium from liquid sources such as brines (naturally occurring and synthesized), leachate solutions from the leaching of minerals or recycled materials, and others are described. The sorbent compounds are characterized by a larger median particle size and coarser particle size distribution that improves commercial synthesis and performance of the sorbent compounds.

### CROSS REFERENCE TO RELATED APPLICATION AND CLAIM OF PRIORITY

The present application claims priority to U.S. provisional patent application No. 63/124,506 filed on Dec. 11, 2020, the entire contents of which are hereby incorporated by reference.

### TECHNICAL FIELD

The invention relates to extraction of lithium from liquid, and more particularly to sorbent compounds useful in the extraction of lithium from liquid sources such as brines, leachate solutions from the leaching of minerals or recycled materials, and others.

### BACKGROUND

Lithium (Li) has emerged as a critical resource in the clean energy transition and may be used in Li-related products and for further fabricating electric energy-storage products, e.g., lithium ion batteries. Brine, such as salt lake brines, containing lithium may be used as a source of lithium. Existing brine extraction methods often make use of salt flats where solar evaporation ponds are created to separate the lithium minerals from the brine. These evaporation processes can be very time-consuming often taking several months or even years to achieve the separation. Further, brines may contain different compounds and ions such as magnesium (Mg), and separating lithium from the other compounds and ions such as magnesium (Mg) may be difficult.

### SUMMARY

This disclosure provides a lithium manganese oxide spinel sorbent compound and methods of making the sorbent. The sorbent may be used to extract lithium from brine.

In one aspect, the disclosure describes a method of preparing a spinel LiMnO sorbent composition for extraction of lithium from liquid sources comprising: Mixing at least one manganese precursor powder (MPP) and at least one lithium precursor power (LPP) to form a precursor powder mixture (PPM); and Calcining the PPM for a time sufficient to form a LiMnO sorbent having a median particle size (MPS) greater than 1 μm.

In some embodiment, the method comprises protonating the PPM with an acid to exchange Li⁺ ions for H⁺ ions to form a protonated form of the LiMnO sorbent.

In some embodiments, the MPS is greater than or equal to 10 μm.

In some embodiments, the MPP comprises MnCO₃ in Rhodochrosite phase.

In some embodiments, the MPP has a mean particle size (MPS) of 50-1000 μm. In some embodiments, the MPS is greater than 100 μm.

In some embodiments, the PPM is calcinated until the LiMnO sorbent has a median particle size (MPS) of 50-1000 μm.

In some embodiments, the LPP is LiOH.

In some embodiments, the calcining time is in a range of 1-24 hours.

In some embodiments, calcining the PPM is conducted in a range of 200-800° C.

In some embodiments, calcining the PPM is conducted at 400-500° C.

In some embodiments, calcining the PPM is conducted with air flow.

In some embodiments, the air flow is circulated at a rate in a range of 0-10 litres per minute (LPM).

In some embodiments, the LiMnO sorbent is Li_{1+X}Mn_{2-Y}O₄ where 0.2≤X≤1.7 and 0.2≤Y≤0.7.

In some embodiments, the LiMnO sorbent is Li_{1+X}Mn_{2-Y}O₄ where 0.3≤X≤0.6 and 0.3≤Y≤0.4.

In some embodiments, the MPP is selected from at least of one of MnO₂, Mn₂O₃, MnCl₂, Mn(OH)₂, Mn₃O₄, MnCO₃, MnCO₃ in rhodochrosite phase, MnSO₄, Mn(NO₃)₂, MnOOH, Mn(CH₃CO₂)₂, and mixtures thereof.

In some embodiments, the LPP is selected from at least one of Li₂O, LiOH, LiOH·H₂O, LiNO₃, LiCl, Li₂CO₃, Li₂SO₄, LiNO₃, LiCH₃CO₂, and mixtures thereof.

In some embodiments, the MPS of the LPP is smaller than the MPS of the MPP.

In some embodiments, the MPP and LPP are mixed at a molar ratio of Li:Mn of 0.5(Li):2(Mn) to 2(Li):1(Mn).

In some embodiments, the MPP and LPP are mixed at a molar ratio of Li:Mn of 0.7(Li):1(Mn) to 1.1(Li):1(Mn).

In some embodiments, the LiMnO sorbent is characterized by a MPS of 2-5,000 μm.

In some embodiments, the LiMnO sorbent is characterized by a MPS of 2-100 μm.

In some embodiments, the LiMnO sorbent is characterized by a MPS of 10-50 μm.

In some embodiments, the LiMnO sorbent is characterized by a MPS of greater than 50 μm.

In some embodiments, the LiMnO sorbent is has a particle size distribution wherein >50% of the particles are larger than at least 10 μm.

In some embodiments, the LiMnO sorbent is has a particle size distribution wherein >75% of the particles are larger than at least 10 μm.

In some embodiments, the LiMnO sorbent is has a particle size distribution wherein >90% of the particles are larger than at least 10 μm.

In some embodiments, the LiMnO sorbent is has a particle size distribution wherein >50% of the particles are larger than at least 40 μm.

In some embodiments, the LiMnO sorbent is has a particle size distribution wherein >75% of the particles are larger than at least 40 μm.

In some embodiments, the LiMnO sorbent is has a particle size distribution wherein >90% of the particles are larger than at least 40 μm.

In some embodiments, the LiMnO sorbent is has a particle size distribution wherein >50% of the particles are larger than at least 100 μm.

In some embodiments, the LiMnO sorbent is has a particle size distribution wherein >75% of the particles are larger than at least 100 μm.

In some embodiments, the LiMnO sorbent is has a particle size distribution wherein >90% of the particles are larger than at least 100 μm.

In some embodiments, the LiMnO sorbent has a particle size distribution wherein at least 50% of the particles are less than 75 μm.

In some embodiments, the LiMnO sorbent is has a particle size distribution wherein at least 75% of the particles are less than 75 μm.

In some embodiments, the LiMnO sorbent is has a particle size distribution wherein at least 90% of the particles are less than 75 μm.

In some embodiments, at least 50% of the LiMnO sorbent is about 1.1 μm.

In some embodiments, the MPP has a MPS of 0.1-5,000 μm.

In some embodiments, the MPP has a MPS of 10-5,000 μm.

In some embodiments, the LPP has a MPS of 0.5-500 μm.

In some embodiments, the method comprises milling the PPM.

In some embodiments, the PPM is milled with at least one of a ball mill, planetary ball mill, jet mill, and/or roller mill.

Embodiments may include combinations of the above features.

In another aspect, the disclosure describes a sorbent composition comprising a sorbent having the general formula Li_{1+X}Mn_{2-Y}O₄ where 0.2≤X≤1.7 and 0.2≤Y≤0.7 and the sorbent having a mean particle size (MPS) greater than 1 μm and wherein the sorbent composition is filterable.

In some embodiments, the MPS is greater than 10 μm.

Embodiments may include combinations of the above features.

In another aspect, the disclosure describes a sorbent composition comprising a sorbent having the general formula Li_{1+X}Mn_{2-Y}O₄ where 0.2≤X≤1.7 and 0.2≤Y≤0.7, the sorbent having a mean particle size (MPS) greater than 10 μm.

In some embodiments, the general formula of the sorbent is Li_{1+X}Mn_{2-Y}O₄ where 0.3≤X≤0.6 and 0.3≤Y≤0.4.

In some embodiments, the sorbent composition has greater than 90% purity of sorbent compound and less than 10% of non-active materials.

In some embodiments, the sorbent composition has greater than 80% purity of sorbent compound and less than 20% of non-active materials.

In some embodiments, the sorbent composition has greater than 70% purity of sorbent compound and less than 30% of non-active materials.

In some embodiments, the sorbent is prepared by any method described in this disclosure.

Embodiments may include combinations of the above features.

In a further aspect, the disclosure describes a use of any sorbent composition described in this disclosure to selectively adsorb lithium from a brine, where the sorbent composition is filterable.

In a further aspect, the disclosure describes a method of separating a sorbent described in this disclosure having a MPS greater than 1 μm from a liquid. The method comprises: introducing a volume of a suspension of a sorbent composition comprising the sorbent and liquid into a separation chamber having a filtration media; and applying a vacuum to the filtration media to separate the liquid from the sorbent; where the liquid is separated from the LiMnO at a rate of at least 10 mL liquid/(sec)(m²).

In some embodiments, the liquid is separated from LiMnO at a rate of 10-1500 mL liquid/(sec)(m²).

In some embodiments, the sorbent composition is prepared by any method described in this disclosure.

Embodiments may include combinations of the above features.

Further details of these and other aspects of the subject matter of this application will be apparent from the detailed description included below and the drawings.

### BRIEF DESCRIPTION OF THE DRAWINGS

Reference is now made to the accompanying drawings, in which:

FIG. 1 shows a graphical comparison of the particle size distribution (PSD) for example LiMnO sorbents made from different example precursor MnCO₃; and

FIG. 2 shows a graphical comparison of a particle size distribution (PSD) of an example LiMnO sorbent made from mineral carbonate.

FIG. 3 shows a schematic flow chart of an example method synthesizing lithium manganese oxide spinel sorbent compounds.

FIG. 4 show a schematic flow chart of an example method for separating a LiMnO sorbent from a liquid (e.g. brine).

### DETAILED DESCRIPTION

Although terms such as “maximize”, “minimize” and “optimize” may be used in the present disclosure, it should be understood that such term may be used to refer to improvements, tuning and refinements which may not be strictly limited to maximal, minimal or optimal.

The term “substantially” as used herein may be applied to modify any quantitative representation which could permissibly vary without resulting in a change in the basic function to which it is related.

In an aspect, this disclosure describes sorbent compounds having a larger median particle size and coarser particle size distribution that improves commercial synthesis and performance of the sorbent compounds. Methods of synthesis of the sorbent compounds are provided which allows for predetermination of sorbent median particle size and particle size distribution to avoid production of fine particles and improve solid-liquid separation.

Current ion-exchange processes for adsorbing and desorbing specific ions from liquid sources generally involve the steps of a) exposing sorbent compounds to a liquid source containing a specific ion of interest b) allowing the sorbent compositions to adsorb the specific ion through ion-exchange and c) subsequently treating the sorbent compound with a desorption fluid to release the specific ion of interest and regenerate the sorbent compound for additional ion-exchange cycles.

Problems with current lithium manganese oxide sorbent compounds may include substantial difficulty separating sorbent compound solids from process fluids during ion-exchange when extracting lithium from liquid sources such as brine. The solid-liquid separation challenges of current lithium manganese oxide sorbents may be a result of very small, often sub-micron, sorbent particles in solution that resist settling and clog filter media as the adsorption and desorption fluids are exchanged. The problem may be further exacerbated as sorbent particles typically exhibit a fine particle size distribution, with a significant percentage of the particles following below 10 μm. Small sorbent particle sizes having a wide particle size distribution are typically a result of the methods of synthesis.

Importantly, while small particles can improve kinetics due to increased surface areas available for ion-exchange, solid-liquid separation efficiency can be reduced in materials that have a small particle size and fine particle size distribution due to dense packing and high pressure drop across membranes, filters etc.

The solid-liquid separation of current lithium manganese oxide sorbents is additionally challenged due to poor particle settling due to the small, often sub-micron, particle size characteristics of these compounds, which limits the applicability of gravity settling methods such as thickening and decanting unit operations, and others. The solid-liquid separation challenges inherent to current lithium manganese oxide sorbent compounds has precluded the application of typical mineral processing unit operations for solid-liquid separation at high throughput using sedimentation or filtration processes such as vacuum filtration, pressure filtration, gravity filtration, thickeners, hydrocyclones, others, and combinations thereof. Instead, current sorbents can only be separated from liquids using methods such as microfiltration, ultrafiltration, and nanofiltration, others and combinations thereof, making them uneconomical.

In order to improve solid-liquid separation performance and efficiency, others have attempted to increase particle size by incorporating the sorbent compounds into a broad variety of media or onto substrates. These larger particles produced using binders, polymers, substrates, etc. have been shown to be effective at improving solid-liquid separation performance, however this improvement has been realized at the expense of lower lithium uptake on a mass basis, slower lithium adsorption and desorption kinetics, increased degradation of sorbent compound and therefore reduced cyclability, and higher manufacturing costs. The sorbent compounds and methods of making the sorbent compounds described herein may be free of binders, polymers, and substrates.

The present invention provides a method of preparing a larger particle size spinel Li_{1+X}Mn_{2-Y}O₄ (where 0.2≤X≤1.7, 0.2≤Y≤0.7, and most preferably 0.3≤X≤0.6, 0.3≤Y≤0.4) sorbent compound (hereinafter referred to as the “sorbent”, “LiMnO sorbent(s)”, and/or “LiMnO sorbent compound(s)”) having a median particle size (MPS) greater than about 10 μm with a coarser particle size distribution wherein at least about 50%, more preferably 75%, and most preferably 90% of the particles are larger than at least 10 μm, more preferably 40 μm, and most preferably 100 μm. In an example, the particle distribution may be in a range of range about 10-5,000 μm. In other embodiments, a median particle size (MPS) of the LiMnO sorbent compound may be greater than about 50 μm with a coarser particle size distribution wherein at least about 50%, more preferably 75%, and most preferably 90% of the particles are larger than at least 38 μm, more preferably 50 μm, and most preferably 200 μm. In an example, the MPS and/or particle distribution may be in a range of range about 10-5,000 μm. In another example, the MPS and/or particle distribution may be 50-1000 μm. The larger particle size sorbents with coarser particle size distribution provide improvements for the extraction of lithium from liquid sources. In other embodiments, the LiMnO sorbent may have an MPS in a range of 0.1-200 μm, and in an example the particle size of the LiMnO sorbent is at least about 50%, more preferably 75%, and most preferably 90% less than 75 μm. In some embodiments, at least 50% of the LiMnO sorbent is about 1.1 μm, e.g. 50% of the LiMnO sorbent may be 0.9-1.3 μm. LiMnO sorbent having smaller particles size, e.g. increased surface area and more ion exchange sites per unit volume/mass in comparison to larger particle size sorbents. As described in this disclosure, LiMnO sorbent compounds may be formed from synthetic MnCO₃ (i.e. synthesized MnCO₃) in some embodiments. In other embodiments, mineral MnCO₃, i.e. MnCO₃ in the rhodochrosite phase, may be used to form LiMnO sorbent. Use of the rhodochrosite phase of MnCO₃ may provide certain properties to LiMnO sorbent such as larger and coarser particle sizes which are easier to separate (e.g. by filtration) from a liquid such as brine, or may provide improved dewatering capabilities.

The manganese compound used in the manganese precursor powder (MPP) to form the spinel LiMnO sorbent may have a predetermined median particle size greater than about 10 μm (range about 0.1-5,000 μm or more preferably 10-5,000 μm) with a coarser particle size distribution wherein at least about 50%, more preferably 75%, and most preferably 90% of the particles are larger than at least 1 μm, preferably 10 μm, more preferably 40 μm, and more preferably 100 μm, and most preferably 200 μm. In some embodiments, the rhodochrosite phase of MnCO₃ may be used as an MPP which may have a particle size in a range of 50-800 μm which may provide a similarly sized spinel sorbent. Increasing the particles size of the MPP may also increase the particle size of the resulting LiMnO sorbent. As describe in this disclosure, rhodochrosite phase of MnCO₃ may be a MPP precursor in the method to form the LiMnO sorbent, which may cause the LiMnO sorbent to have reduced shrinkage during calcination. Increasing the particle size of the LiMnO sorbent may enhance separation from of the LiMnO sorbent from liquid (e.g. brine) to minimize sorbent losses during filtering, reduce filter pressure drop, and improve dewatering.

The lithium oxide and/or salt, i.e. the Lithium precursor powder (LPP), used to form the spinel LiMnO sorbent may have a predetermined median particle size smaller than the median particle size of manganese salt powder. In some embodiments, the lithium oxide and/or salt preferably has a particle size of about 0.5-500 μm, preferably 0.5-15 μm, preferably below 10 μm, more preferably below, 5 μm and most preferably below 2 μm. In a first embodiment, the method of preparing the spinel LiMnO (e.g. Li_{1+X}Mn_{2-Y}O₄ (where 0.2≤X≤1.7, 0.2≤Y≤0.7, and most preferably 0.3≤X≤0.6, 0.3≤Y≤0.4)) sorbent compound includes the steps of mixing precursor compounds including at least one manganese compound with at least one lithium compound and calcining the mixture in one or more steps within specific temperature ranges (400-500° C.).

In one embodiment, to promote uniform mixing of the manganese and lithium precursors and to maximize the number of active ion-exchange sites while providing a particle size enabling efficient liquid-solid separation, the median particle size of the lithium compound should be less than that of the manganese compound.

In another embodiment, the particle size distribution of the precursor manganese compound used to prepare the spinel LiMnO sorbent compound has a direct impact on the particle size distribution of the spinel LiMnO sorbent compound and therefore it is preferable that the precursor manganese compound has a relatively large median particle size greater than about 10 μm (range about 1-5,000 μm) with a coarser particle size distribution at least about 50%, more preferably 75%, and most preferably 90% of the particles are larger than at least 1 μm, preferably 10 μm, more preferably 40 μm, and most preferably 100 μm.

Methods for preparing spinel LiMnO sorbent compounds for the extraction of lithium from liquid sources are known, however the sorbent compounds produced through current methods have been difficult to use in commercial applications due to the small particle size and fine particle size distribution of the known compounds. Small particle size, e.g. less than 10 μm, particularly combined with the fine particle size distribution, has tended to present challenges during solid-liquid separation, resulting in high pressure drop across filters, membranes, screens etc. and very slow filtration and sedimentation rates. Extraction of lithium from a liquid source using a sorbent typically requires numerous solid-liquid separation steps for each extraction/stripping cycle following protonation of the calcined sorbent, washing of the protonated sorbent, loading lithium onto the sorbent from the liquid source, washing the loaded sorbent, and stripping lithium from the sorbent into a desorbent acid. Until now, challenges with inefficient and slow solid-liquid separation of sorbent compounds with small particle size and fine particle size distribution, especially at high throughputs, have inhibited industrial application of known sorbent compounds.

Methods of improving efficiency of solid-liquid separation by combining known sorbent compounds into larger particles using binders and other additives are also known. Although these known larger particles are effective at overcoming current solid-liquid separation limitations, by introducing additional materials (“Non-Active Materials”) which are not active in the extraction of lithium and therefore increasing diffusion limitations through the particle, these larger particles exhibit lower lithium uptake on a mass basis, slower lithium extraction and desorption kinetics, lower selectively for lithium over other cations, which results in generally lower performance and poorer economics.

The methods of preparing a larger particle size spinel LiMnO sorbent compound with a coarser particle size distribution, which results in significant performance improvements for the extraction of lithium from liquid sources are described in more detail here. By increasing the particle size and coarsening the particle size distribution of the spinel LiMnO sorbent compound, solid-liquid separation of the sorbent compound from process fluids may be significantly improved. The methods of this disclosure may also significantly improve solid-liquid separation without introduction of Non-Active Materials which are not active in the extraction of lithium (i.e. binders, substrates, additives, etc.), the resulting spinel LiMnO sorbent compound maintains high lithium uptake on a mass basis, fast lithium extraction and desorption kinetics, high selectively for lithium over other cations, which results in generally higher performance and improved economics.

In another embodiment, this disclosure provides a method of preparing a larger particle size spinel LiMnO sorbent compound with a coarser particle size distribution, which results in significant performance improvements for the extraction of lithium from liquid sources. As noted above, larger particle size spinel LiMnO sorbent compounds described herein may be greater than about 1 μm, preferable greater than about 10 μm, and more preferably greater than about 50 μm. By increasing the particle size, decreasing the percentage of fine particles, and coarsening the particle size distribution of the spinel LiMnO sorbent compound, solid-liquid separation of the sorbent compound from process fluids is significantly improved. In other words, reducing fine particles means removing the smaller particle size tail of the sorbent size distribution which may provide a LiMnO sorbent compound that has more active sites for Li adsorption and is easier to filter due to its increase size. For synthetic LiMnO sorbent compound made from synthetic MnCO₃, fine particles, e.g. particles smaller than 10 μm may be wet-sieved to remove finer/smaller particles. For LiMnO sorbent compound made from MnCO₃ in rhodochrosite phase the smaller particles not need to be sieved out as the particle size for MnCO₃ and the resulting LiMnO sorbent compound is greater than 10 μm (e.g. specifically greater than 50 μm).

In another embodiment, this disclosure provides a method of preparing a larger particle size spinel LiMnO sorbent compound with a coarser particle size distribution, which enables the application of typical mineral processing unit operations for solid-liquid separation at high throughput using sedimentation or filtration processes such as vacuum filtration, pressure filtration, gravity filtration, thickeners, hydrocyclones, others, and combinations thereof.

In another embodiment, the methods of this disclosure may provide a significantly improved solid-liquid separation characteristic of the sorbent without introduction of Non-Active Materials which are not active in the extraction of lithium. The resulting spinel LiMnO sorbent compound may maintain high lithium uptake on a mass basis, fast lithium extraction and desorption kinetics, high selectively for lithium over other cations, which results in generally higher performance.

In another embodiment, the methods described in this disclosure may provide a method of preparing a larger particle size spinel LiMnO sorbent compound with a predominantly monodisperse particle size, substantially larger than filtration media, with low fines which are substantially similar in size to the filtration media. These characteristics enable the application of typical mineral processing unit operations for solid-liquid separation at high throughput using sedimentation or filtration processes such as vacuum filtration, pressure filtration, gravity filtration, thickeners, hydrocyclones, others, and combinations thereof.

In another embodiment, the methods of this disclosure may provide a method of preparing a larger particle size spinel LiMnO sorbent compound with a coarser particle size distribution, which retains its large particle size and coarser size distribution through many cycles of lithium extraction from liquid sources, lithium stripping from the sorbent into a desorption fluid, and intermediate sorbent washing steps, which results in maintenance of the improved solid-liquid separation efficiency as well as lithium extraction performance over numerous cycles.

These and other features and advantages of the present invention will become more readily apparent to those skilled in the art upon consideration of the following drawings which illustrate aspects of the LiMnO sorbent compound's described herein.

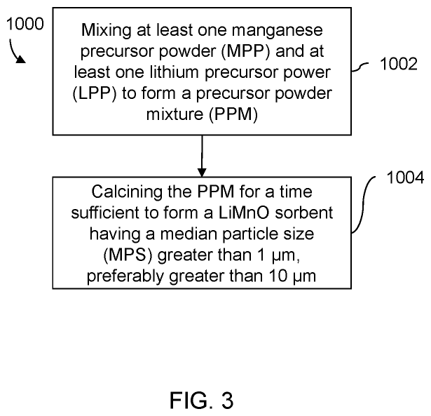

The sorbent compounds are prepared according to the following general steps which are illustrated in the example method of FIG. 3. FIG. 3 is a flow chart depicting example method 1000 for making a sorbent compound according to this disclosure.

Combination of Lithium and Manganese Precursors

At block 1002, example method 1000 comprises mixing at least one manganese precursor powder (MPP) and at least one lithium precursor power (LPP) to form a precursor powder mixture (PPM). Mixing in an aqueous solutions is not part of this example method. In an embodiment, at least one larger particle size MPP (e.g. manganese salt and/or oxide powder) with coarse size distribution having a median particle size greater than about 1 μm, e.g. in the range about 1-5,000 μm, together with a coarser particle size distribution wherein at least about 50%, more preferably 75%, and most preferably 90% of the particles are larger than at least 1 μm, preferably 1 μm, more preferably 40 μm, and most preferably 100 μm is mixed with a smaller particle size lithium salt and/or oxide powder (lithium precursor powder (LPP)) having a median particle size smaller than the MPS of the MPP and in the range of about 0.5-500 μm. The LPP may be milled, e.g. by a roller mill to a desired particle size. For example, LiOH may be milled from 60 μm to less than 20 μm. The LPP MPS is preferably 0.5-15 μm, preferably below 10 μm, more preferably below, 5 μm and most preferably below 2 μm. In some embodiments, rhodochrosite phase of MnCO₃ may be used as an MPP which may have a particle size in a range of 50-1000 μm which may provide a similarly sized spinel sorbent. Larger sized MPP, e.g. greater than 10 μm, may provide a LiMnO sorbent that is rich in ion exchange sites. Example larger particle size MPP include rhodochrosite phase of MnCO₃ or large size synthetic manganese carbonate reagent (d50>=10 micron). Rhodochrosite phase of MnCO₃ may have a MPS of greater than 100 μm and may comprise FeCO₃ and other transition metal ion carbonates. Any lithium precursor power (LPP), may be combined with rhodochrosite phase of MnCO₃ to for the precursor powder mixture. In the examples, anhydrous LiOH was used.

In an embodiment, at block 1002, the precursors powders are mixed together at a Li:Mn molar ratio of 0.5:2 to 2:1, preferably 0.8:1.0. In another embodiment, the precursors powders are mixed together at a Li:Mn molar ratio of 0.7:1 to 1.1:1.

Exemplary manganese salts and oxides include MnO₂, Mn₂O₃, Mn₃O₄, MnCO₃, MnCO₃ (Rhodochrosite Phase), MnSO₄, Mn(NO₃)₂, MnOOH, Mn(CH₃CO₂)₂, and mixtures thereof.

Exemplary lithium salts and oxides include Li₂O, LiOH, LiOH·H₂O, LiNO₃, Li₂CO₃, Li₂SO₄, LiNO₃, LiCH₃CO₂, and mixtures thereof.

The MPPs may be purchased or sieved, centrifuged, or otherwise reduced in size and/or classified to meet the larger median particle size and coarser particle size distribution described by this disclosure.

The LPPs may be purchased or are micronized, milled in a ball mill, planetary ball mill, jet mill, roller mill or other mill, possibly containing a mixing media added to break up agglomerates, for 30 minutes to 12 hours, most preferably 7 hours to produce a lithium salt and/or oxide powder with a MPS smaller than the manganese salt and/or oxide powder.

The manganese salt and/or oxide powder and lithium salt and/or oxide powder mixture may be thoroughly mixed manually, with a stirrer, in a roller mill, or other mixer. In an example, after the PPM is formed, the PPM may be introduced into a roller mill and roller milling to form a roller mill precursor mixture (RMPM).

Additives, such as complexing agents and/or oxidants are not required in the methods and LiMnO sorbents describe herein. As such, the PPM and resulting sorbents may be free of additives such as complexing agents and/or oxidants.

Calcination

At block 1004, method 1000 comprises calcining the PPM for a time sufficient to form a LiMnO sorbent having a median particle size (MPS) greater than 1 μm. During calcining, the LPP may decompose into an intermediary which may bond with MnₐO_{b} (where MnₐO_{b} is an intermediate compound of the MPP and/or LPP formed during calcining). In an example, LiOH may decompose into Li₂O which may bond with Mn a O_{b} during calcination. In an embodiment, the MPS is greater than or equal to 10 μm. In other examples, the LiMnO sorbent may have an MPS in a range of 1-5000 μm, 2-100 μm, 10-50 μm, or greater than 50 μm. In an example, after thorough mixing, the powdered mixture is placed in a furnace (tube, muffle or other) for calcination under airflow to form the LiMnO sorbent compound having a large median particle size and coarse particle size distribution approximately equivalent to the manganese salt and/or oxide described above. In an example, the air flow is circulated at a rate in a range of 0-10 litres per minute (LPM). Calcining the powdered mixture may be conducted in a range of 200-800° C. In an embodiment, the powdered mixture may be calcinated at 400-500° C. Calcination time may range from 1-24 hours. LiMnO sorbent made from rhodochrosite phase of MnCO₃ as MPP may have a MPS of greater than 100 μm and may comprise FeCO₃ and other transition metal ion carbonates which may require longer calcination time. Notably, in comparison to sorbent made from synthetic MnCO₃, sorbent made from rhodochrosite phase of MnCO₃ according to this disclosure shrinks less in size during calcination resulting in a an LiMnO sorbent with a larger comparative particle size.

LiMnO sorbent size is may be effected by choice of MPP, e.g. synthetic MnCO₃ may decrease LiMnO sorbent size in comparison to rhodochrosite phase of MnCO₃. Milling may also be used to reduce LiMnO sorbent size, e.g. using roller mill.

Protonation, Lithium Treatment and Sorbent Regeneration

After calcination, the LiMnO sorbent compound may be mixed with an acid to exchange Li⁺ ion for H⁺ ion, thereby forming a protonated form of the sorbent compound which can be used to extract lithium from a liquid source by exchanging a H⁺ ion from the sorbent compound with a Li⁺ ion from the liquid source.

Treatment with the liquid source exchanges H⁺ ions for Li⁺ ions in the protonated form of the sorbent composition through ion exchange. Adsorbed lithium in the sorbent is released by treatment with acid to re-exchange H⁺ ions for Li⁺ ions and to regenerate the sorbent.

The treatment (Li⁺ ion adsorption) step and desorption/regeneration (Li⁺ desorption) step each require separation of the sorbent solid from the liquid source and desorption fluid, respectively.

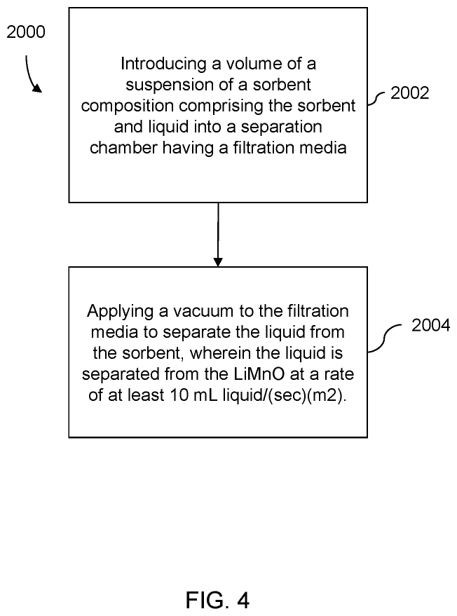

FIG. 4 is a flow chart depicting example method 2000 for separating a LiMnO sorbent of this disclosure having a MPS greater than 2 μm from a liquid (e.g. brine).

At block 2002, the method comprises introducing a volume of a suspension of a sorbent composition comprising the sorbent and liquid into a separation chamber having a filtration media.

At block 2004, the method comprises applying a vacuum to the filtration media to separate the liquid from the sorbent. The liquid may be separated from the LiMnO at a rate of at least 10 mL liquid/(sec)(m2). In an embodiment, the liquid is separated from LiMnO at a rate of 10-1500 mL liquid/(sec)(m²) which may be achieved by using a sorbent according to this disclosure made from MnCO₃ in rhodochrosite phase.

### EXAMPLES

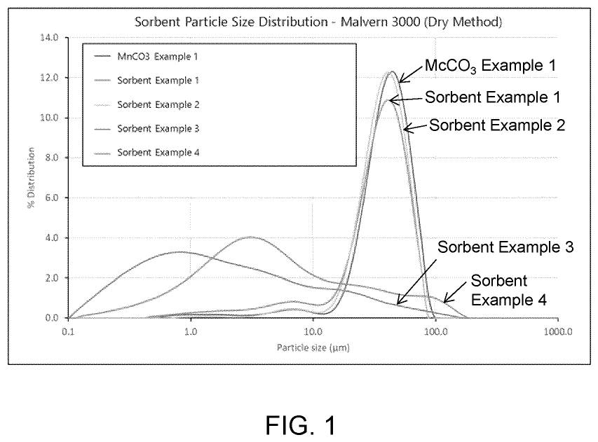

FIG. 1 is a graph illustrating the comparison between the particle size distribution of a large particle size, coarse, substantially monodispersed particle size distribution, precursor MnCO₃, the spinel LiMnO sorbent compound produced using a large particle size, coarse, substantially monodispersed particle size distribution, precursor MnCO₃ with micronized LiOH·H₂O (calcined and protonated forms), and two other spinel LiMnO sorbent compounds obtained using different methods and different manganese and lithium precursor species.

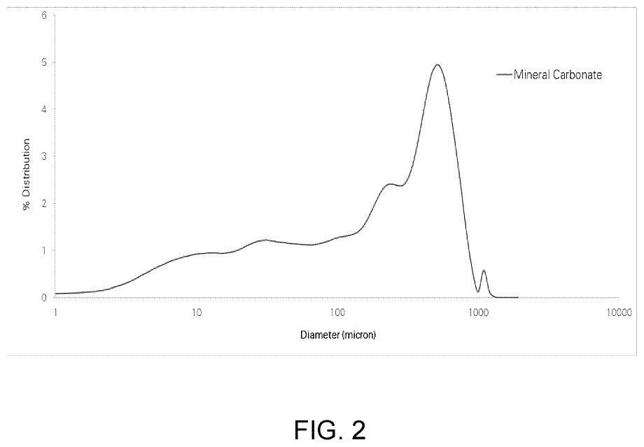

FIG. 2 is a Particle size distribution (PSD) data of mineral carbonate based LiMnO sorbent (Sorbent Example 7 in Table 1 below).

Table 1 below describes the example LiMnO sorbent compounds of FIGS. 1 and 2, as well as an example synthetic MnCO₃ reagent including sorbent and precursor particle sizes. As shown, in Examples 1 and 2 utilize synthetic MnCO₃ (D50: 43 μm) and micronized LiOH H₂O to provide a LiMnO sorbent having a median particle size of 38-40 μm. The median particle size of LiMnO sorbent produced by the methods described in Examples 1 and 2 may be in the range of 2-5,000 μm. In an example, the sorbent may be in a range of 1-100 μm, 10-15 μm, or greater than 50 μm. The particle size of the sorbent may be increased by using larger particle MnCO₃. Examples 3-5 provided sorbent having a median particle size of at most 13 μm with typical median particle sizes less than 10 μm. Examples 6 and 7 utilized MnCO₃ (Rhodochrosite Phase) and LiOH anhydrous as reagents which produced the largest sorbent having median particle size of about 110 μm and 267 μm respectively. Median particle sizes produced by the method of Example 6, which use MnCO₃ (Rhodochrosite Phase), may be in a range of 10-200 μm depending on the particle size of the reagents, in particular the size of manganese precursor powder, and grinding time. The median particles particle sizes produced by the method of Example 7 which use MnCO₃ (Rhodochrosite Phase), may be in a range of 100-500 μm depending on the particle size of the reagents, in particular the manganese precursor powder.

TABLE 1

| | | Mn | Li | Sorbent |
|---|---|---|---|---|
| | | Precursor | Precursor | Median |
| Example | Description | Median and | and Particle | particle size |
| MnCO₃ | Large particle size, coarse, | N/A | N/A | 43 (note: this is |
| Example 1 | substantially monodispersed | | | the particle size |
| | particle size distribution, | | | of MnCO₃) |
| | MnCO₃ | | | |
| Sorbent | Sorbent compound obtained | MnCO₃ (D50: | LiOH•H₂O | 38 |
| Example 1 | from combining micronized | 43 μm) | micronized | |
| | LiOH•H₂O + large particle | | (~1 μm) | |
| | size, coarse, substantially | | | |
| | monodispersed particle size | | | |
| | distribution, MnCO₃ in a | | | |
| | roller mill prior to calcination | | | |
| | (calcined form) | | | |
| Sorbent | Sorbent compound obtained | MnCO₃ (D50: | LiOH•H₂O, | 40 |
| Example 2 | from combining micronized | 43 μm) | micronized | |
| | LiOH•H₂O + large particle | | (~1 μm) | |
| | size, coarse, substantially | | | |
| | monodispersed particle size | | | |
| | distribution, MnCO₃ in a | | | |
| | roller mill prior to calcination | | | |
| | (protonated form) | | | |
| Sorbent | Sorbent compound obtained | MnCO₃ | LiOH | 1.1 |
| Example 3 | from combining LiOH | (90% <75 μm) | Anhydrous | |
| | anhydrous + MnCO₃ in a | | (50-500 μm) | |
| | planetary ball mill prior to | | | |
| | calcination (calcined form) | | | |
| Sorbent | Sorbent compound obtained | Manganese | Lithium | 13 |
| Example 4 | from mixing manganese | Nitrate | Acetate | |
| | nitrate and lithium acetate at | (liquid phase | Synthesis | |
| | 100° C. prior to calcination | synthesis, | (liquid | |
| | (liquid phase synthesis, no | no milling) | phase | |
| | milling, calcined form) | | synthesis, | |
| | | | no milling) | |
| Sorbent | Sorbent compound obtained | MnCO₃ | LiOH. | <5 |
| Example 5 | from combining LiOH | (D50: 43 μm) | Anhydrous | |
| | anhydrous + large particle | | (50-500 μm) | |
| | size, coarse, substantially | | | |
| | monodispersed particle size | | | |
| | distribution, synthetic MnCO₃ | | | |
| | in a planetary ball mill prior | | | |
| | to calcination | | | |
| Sorbent | Sorbent compound obtained | MnCO3 (PSD | Anhydrous (5 | 110 |
| Example 6 | from Mineral MnCO3 | Range: 44- | LiOH 0-500 μm) | |
| | Large particle size, coarse, | 595 μm) | | |
| | particle size distribution, | | | |
| | Mineral MnCO3 (Rhodochrosite | | | |
| | Phase) + LiOH anhydrous in | | | |
| | a roller mill grinded for 2 hr | | | |
| | prior to calcination (calcined | | | |
| | form) | | | |
| Sorbent | Sorbent compound obtained | MnCO3 | LiOH | 267 |
| Example 7 | from Mineral MnCO3 | (PSD range: | Anhydrous | |
| | Large particle size, coarse, | 595-841 μm) | (50-500 μm) | |
| | particle size distribution, | | | |
| | Mineral MnCO3 (Rhodochrosite | | | |
| | Phase) + LiOH anhydrous in | | | |
| | a roller mill mixed for 0.5 hr | | | |
| | prior to calcination (calcined | | | |
| | form) | | | |

The example sorbent's described in Table 1 were tested to evaluate extraction of lithium from brine; stripping efficiency of lithium from each example sorbent; lithium recovery; and lithium uptake onto the example sorbents. Table 2 illustrates the results of the studies of examples 1-7. As shown in Table 2, Examples 1˜4 provided similar lithium recovery rates in the range of 71-75% whereas example sorbents 6 and 7 which were produced from MnCO₃ (Rhodochrosite Phase) exhibited lithium recovery in the range of 5-26%. Lithium recovery rates are based on the recover from the initial brine sample. The reduced extraction of examples 6 and 7 was expected due to diffusional resistance resulting from lowering surface area of the sorbent particles as the particle size increased.

TABLE 2

| | | | | Lithium |
|---|---|---|---|---|
| | Lithium | Stripping | Lithium | uptake, |
| | extraction, | efficiency, | recovery, | mg Li/g |
| Example | % Li | % Li | % Li | sorbent |
| Sorbent Example 1 | 68% | 104% | 71% | 24 |
| and 2 | | | | |
| Sorbent Example 3 | 83% | 87% | 72% | 25 |
| Sorbent Example 4 | 89% | 85% | 75% | 31 |
| Sorbent Example 5 | 76% | 84% | 64% | 22 |
| Sorbent Example 6 | 28% | 93% | 26% | 11 |
| Sorbent Example 7 | 22% | 25% | 5% | 9.0 |

The example sorbent's described in Table 1 were also tested to evaluate the filtration rate. Table 3 illustrates Benchtop scale sorbent vacuum filtration rates for mineral MnCO₃ and synthetic MnCO₃ based sorbents during the extraction step.

TABLE 3

| | | | Filtration |
|---|---|---|---|
| | | Sorbent Median | Rate/Area |
| | | particle size | (mL Brine/ |
| Example | Description | (D50), μm | sec*m²) |
| Sorbent | Sorbent compound obtained from | 38 | 468 |
| Example 1 | combining micronized LiOH•H2O + | | |
| | large particle size, coarse, | | |
| | substantially monodispersed | | |
| | particle size distribution, MnCO3 | | |
| | in a roller mill prior to calcination | | |
| | (calcined form) | | |
| Sorbent | Sorbent compound obtained from | 1.1 | 58 |
| Example 3 | combining micronized LiOH | | |
| | anhydrous + MnCO3 in a roller mill | | |
| | prior to calcination (calcined form) | | |
| Mineral MnCO3 | Large particle size, coarse, | 110 | 625 |
| Sorbent Example 6 | particle size distribution, Mineral | | |
| | MnCO3 (Rhodochrosite Phase) + | | |
| | LiOH anhydrous in a roller mill grinded | | |
| | for 2 hr prior to calcination (calcined | | |
| | form) | | |
| Mineral MnCO3 | Large particle size, coarse, | 267 | 919 |
| Sorbent Example 7 | particle size distribution, Mineral | | |
| | MnCO3 (Rhodochrosite Phase) + | | |
| | LiOH anhydrous in a roller mill mixed | | |
| | for 0.5 hr prior to calcination (calcined | | |
| | form) | | |

As shown in Table 3, mineral carbonate MnCO₃ (Rhodochrosite Phase) based sorbent (i.e. examples 6 and 7) shows a higher filtration rate during extraction step due to its large particle size which may result in higher overall process efficiency and higher dewatering in comparison to sorbent's having a smaller MPS. The filtration rates for mineral carbonate based sorbent can range from 1-25 times compared to small size synthetic MnCO₃ based sorbent (sorbent example 3) as shown in Table 1. Additionally, the mineral carbonate (Rhodochrosite phase) MnCO₃ based sorbent (e.g. example 6 and 7) may be used in column bed ion exchange process to provide negligible pressure drop during extraction-desorption cycle. As anticipated, mineral carbonate MnCO₃ based sorbent of examples 6 and 7 displayed a moderate lithium extraction % (shown in Table 2) due to diffusional resistance resulting from lowering surface area of the particles.

### SYNTHESIS EXAMPLES

Spinel LiMnO sorbent compound (Sorbent Example 1 and Sorbent Example 2 in Table 1 and FIG. 1) was synthesized at a 100 g scale.

A large particle size, coarse particle size distribution, MnCO₃ (D50: 43 μm, MnCO₃ Example 1 in Table 1) was combined with micronized LiOH·H₂O (D50: 1 μm) at a Li:Mn molar ratio of 0.8:1.0 and mixing media in a roller mill for 1 hour at 100 RPM.

The combined material was transferred to an alumina crucible which was placed in a ThermcraftXST split tube or Fisher Scientific Isotemp 650-750 series muffle furnace under active 1 L/min flow of air and heated to 450° C. at a ramp rate of 3° C./min. Once the calcination temperature of 450° C. was reached, the material was left to calcine under 1 L/min flow of air for 12 hours.

After calcination, the sample was left in the furnace to cool to room temperature.

To enable exchange of Li⁺ ions in the sorbent compound with H⁺ ions from a protonation acid in preparation for lithium extraction from a liquid resource, the calcined sorbent was stirred in 0.5 M H₂SO₄ at a ratio of 10 g/L sorbent to protonation acid at room temperature for 1 hour. The protonated sample was then separated from the protonation acid via filtration using filter paper on a Büchner funnel.

### Comparative Example 1

Two sorbents were prepared using different methods and manganese and lithium precursors. The first sorbent, Sorbent Example 3 in Table 1, was obtained by combining lithium hydroxide anhydrous (50-500 μm) with a small particle size manganese carbonate (90%<75 μm) in a planetary ball mill for 30 minutes at 600 RPM. The second sorbent, Sorbent Example 1 in Table 1, was obtained by following method using a larger particle size manganese carbonate (D50: 43 μm) with a micronized LiOH·H₂O (D50: 1 μm) in a roller mill for 1 hour with alumina bead mixing media to break up agglomerates. Both sorbents were calcined for 12 hours at 450° C. under 1 LPM air.

3 g of the first sorbent, Sorbent Example 3 in Table 1 (D50: 1.1 μm), was mixed with 300 mL of lithium containing brine and gravity filtered on a 5.5 cm Büchner funnel with filter paper. Required filter time for this sorbent was almost 2 hours at a filtration rate of approximately 2.5 mL/minute.

10 g of the second sorbent, Sorbent Example 1 in Table 1 (D50: 40 μm), was mixed with 1 L of lithium containing brine and gravity filtered on a 5.5 cm Büchner funnel with filter paper. Required filter time for this sorbent was approx. 12 minutes at a filtration rate of approximately 83.3 mL/minute.

This example demonstrates that filtration was significantly improved for the second sorbent, Sorbent Example 1 in Table 1, which was obtained by following the present invention method and exhibited a larger median particle size and coarser particle size distribution.

### Comparative Example 2

Two sorbents were prepared using different methods and manganese and lithium precursors. The first sorbent, Sorbent Example 4 in Table 1, was obtained by mixing lithium acetate with manganese nitrate at 100° C. for 1 hour. The second sorbent, Sorbent Example 1 in Table 1, was obtained by following the present invention method using a larger particle size manganese carbonate (D50: 43 μm) with a micronized LiOH·H₂O (D50:1 μm) in a roller mill for 1 hour with alumina bead mixing media to break up agglomerates. Both sorbents were calcined for 12 hours at 450° C. under 1 LPM air.

1 g of the first sorbent, Sorbent Example 4 in FIG. 2 (D50: 13 μm), was mixed with 100 mL of water and vacuum filtered on a 5.5 cm Büchner funnel using an aspirator (estimated vacuum of 10 torr). Required filter time for this sorbent was almost 2 minutes at a filtration rate of approximately 53 mL/minute.

10 g of the second sorbent, Sorbent Example 1 in FIG. 2 (D50: 40 μm), was mixed with 1 L of lithium containing brine and gravity filtered on a 5.5 cm Büchner funnel with filter paper. Required filter time for this sorbent was approximately 12 minutes at a filtration rate of approximately 83.3 mL/minute.

This example demonstrates that filtration was significantly improved for the second sorbent, Sorbent Example 1 in FIG. 2, even when gravity filtered without vacuum, which was obtained by following the present invention method and exhibited a larger median particle size and coarser particle size distribution.

### Comparative Example 3

The particle size distribution was measured via Malvern 3000 dry method for sorbent synthesized per “Synthesis Example” above, both in calcined (Sorbent Example 1 in Table 1), and protonated form (Sorbent Example 2 in Table 1) and the manganese precursor used to synthesize said sorbents (MnCO₃ Example 1 in Table 1). Measured particle size distributions are shown in FIG. 1.

This example demonstrates that by following the present invention method, the larger particle size spinel LiMnO sorbent compound with a coarser particle size distribution retains the large particle size and coarse size distribution exhibited by the MnCO₃ precursor through mixing, calcination and protonation (exchange of Li⁺ ion from the sorbent with H⁺ ion in acid).

### Comparative Example 4

Three sorbents were prepared using different methods and manganese and lithium precursors. The first sorbent, Sorbent Example 3 in Tables 1 and 2, was obtained by combining lithium hydroxide anhydrous (D50: 50-500 μm) with a small particle size manganese carbonate (90%<75 μm) in a planetary ball mill for 30 minutes at 600 RPM. The second sorbent, Sorbent Example 1 and 2 in Table 1 and 2, was obtained by following the present invention method using a larger particle size manganese carbonate (D50: 43 μm) with a micronized LiOH·H₂O (D50: 1 μm) in a roller mill for 1 hour with alumina bead mixing media to break up agglomerates. The third sorbent, Sorbent Example 4 in Tables 1 and 2, was obtained by mixing manganese nitrate and lithium acetate on a hot plate at 100° C. for an hour (liquid phase synthesis, no milling). All sorbents were calcined for 12 hours at 450° C. under 1 LPM air.

The three sorbents obtained were protonated by combining them with 0.5 M H₂SO₄ at a ratio of 10 g/L sorbent to protonation acid for 1 hour to exchange Li⁺ ions in the sorbents for H⁺ ions in the protonation acid in preparation for lithium extraction from brine. Each of the three sorbents were separated from the 0.5 M H₂SO₄ protonation solution by vacuum filtration on a Büchner funnel and then washed with water. Each of the three washed sorbents were then mixed with brine at a ratio of 2 g/L sorbent to brine for 15 minutes during which time lithium was extracted from the brine onto the sorbent through exchange of H⁺ ions on the protonated sorbent with Li⁺ ions in the brine. Each of the three sorbents were separated from the brine by vacuum filtration on a Büchner funnel and then washed with water. Each of the three washed sorbents were then mixed with 0.5 M H₂SO₄ at a ratio of 40 g/L sorbent to desorbent acid for 15 minutes during which time lithium was stripped from the sorbent into the desorbent acid through exchange of Li⁺ ions on the lithiated sorbent with H⁺ ions in the desorbent acid.

ICP-OES analysis of the brine prior to extraction and desorbent acid after stripping in Table 2 show that all three sorbents obtained a lithium concentration factor of approximately 15, with lithium extraction from brine ranging from 68% to 89%.

This example demonstrates that the sorbent obtained by following the present invention method (Sorbent Examples 1 and 2) exhibits a high lithium concentration factor and lithium extraction efficiency similar to sorbents obtained through other methods.

### Comparative Examiner 5

As noted in Table 1, Example 6 and 7 each provide a LiMnO sorbent made from MnCO₃ (Rhodochrosite Phase) as a regent. Synthesis of LiMnO sorbent using mineral MnCO₃ (Rhodochrosite Phase) in Example 6 and 7 provided a higher filtration rate during extraction step due to its large particle size resulting in higher process efficiency. The filtration rates for sorbent produced from mineral carbonate can range from 1-25 times compared to small size synthetic MnCO₃ based sorbent (sorbent example 3) as shown in Table 3. Additionally, the mineral carbonate MnCO₃ (example 6 and 7) may be advantageous in column bed ion exchange process due to negligible pressure drop during extraction-desorption cycle. As anticipated, mineral carbonate MnCO₃ (example 6 and 7) based sorbent displayed a moderate lithium extraction % due to diffusional resistance resulting from lowering surface area of the particles.

Synthesis conditions for sorbent examples 6 and 7:
Roller mill rpm=0-200 rpm
Calcination temperature=400-600° C.
Air flow rate=0-10 LPM
   The reagents were calcined at the above mentioned temperatures.

Although the present invention has been described and illustrated with respect to preferred embodiments and preferred uses thereof, it is not to be so limited since modifications and changes can be made therein which are within the full, intended scope of the invention as understood by those skilled in the art.

1. A method of preparing a spinel LiMnO sorbent composition for extraction of lithium from liquid sources comprising:
a. Mixing at least one manganese precursor powder (MPP) and at least one lithium precursor power (LPP) to form a precursor powder mixture (PPM);
b. Calcining the PPM for a time sufficient to form a LiMnO sorbent having a median particle size (MPS) greater than 1 μm.

2. The method of claim 1, comprising protonating the PPM with an acid to exchange Li⁺ ions for H⁺ ions to form a protonated form of the LiMnO sorbent.

3. The method of any one of claims 1-2, wherein the MPS is greater than or equal to 10 μm.

4. The method of any one of claims 1-3, wherein the MPP comprises MnCO₃ in Rhodochrosite phase.

5. The method of any one of claims 1-4, wherein MPP has a mean particle size (MPS) of 50-1000 μm.

6. The method of any one of claims 1-5, wherein the MPS is greater than 100 μm.

7. The method of any one of claims 1-6, wherein the PPM is calcinated until the LiMnO sorbent has a median particle size (MPS) of 50-1000 μm.

8. The method of any one of claims 1-7, wherein the LPP is LiOH.

9. The method of any one of claims 1-8, wherein the time is in a range of 1-24 hours.

10. The method of any one of claims 1-9, wherein calcining the PPM is conducted in a range of 200-800° C.

11. The method of claim 10, wherein calcining the PPM is conducted at 400-500° C.

12. The method of any one of claims 1-11, wherein calcining the PPM is conducted with air flow.

13. The method of claim 12, wherein the air flow is circulated at a rate in a range of 0-10 litres per minute (LPM).

14. The method of any one of claims 1-13, wherein the LiMnO sorbent is Li_{1+X}Mn_{2-Y}O₄ where 0.2≤X≤1.7 and 0.2≤Y≤0.7.

15. The method of claim 14, wherein the LiMnO sorbent is Li_{1+X}Mn_{2-Y}O₄ where 0.3≤X≤0.6 and 0.3≤Y≤0.4.

16. The method of any one of claims 1-15, wherein the MPP is selected from at least of one of MnO₂, Mn₂O₃, MnCl₂, Mn(OH)₂, Mn₃O₄, MnCO₃, MnCO₃ in rhodochrosite phase, MnSO₄, Mn(NO₃)₂, MnOOH, Mn(CH₃CO₂)₂, and mixtures thereof.

17. The method of any one of claims 1-16, wherein the LPP is selected from at least one of Li₂O, LiOH, LiOH·H₂O, LiNO₃, LiCl, Li₂CO₃, Li₂SO₄, LiNO₃, LiCH₃CO₂, and mixtures thereof.

18. The method of any one of claims 1-17 wherein the MPS of the LPP is smaller than the MPS of the MPP.

19. The method of any one of claims 1-17, wherein the MPP and LPP are mixed at a molar ratio of Li:Mn of 0.5(Li):2(Mn) to 2(Li):1(Mn).

20. The method of any one of claims 1-19, wherein the MPP and LPP are mixed at a molar ratio of Li:Mn of 0.7(Li):1(Mn) to 1.1(Li):1(Mn).

21. The method of any one of claims 1-20, wherein the LiMnO sorbent is characterized by a MPS of 2-5,000 μm.

22. The method of any one of claims 1-21, wherein the LiMnO sorbent is characterized by a MPS of 2-100 μm.

23. The method of any one of claims 1-22, wherein the LiMnO sorbent is characterized by a MPS of 10-50 μm.

24. The method of any one of claims 1-23, wherein the LiMnO sorbent is characterized by a MPS of greater than 50 μm.

25. The method of any one of claims 1-24, wherein the LiMnO sorbent is has a particle size distribution wherein >50% of the particles are larger than at least 10 μm.

26. The method as in any one of claims 1-24, wherein the LiMnO sorbent is has a particle size distribution wherein >75% of the particles are larger than at least 10 μm.

27. The method of any one of claims 1-24, wherein the LiMnO sorbent is has a particle size distribution wherein >90% of the particles are larger than at least 10 μm.

28. The method of any one of claims 1-24, wherein the LiMnO sorbent is has a particle size distribution wherein >50% of the particles are larger than at least 40 μm.

29. The method of any one of claims 1-24, wherein the LiMnO sorbent is has a particle size distribution wherein >75% of the particles are larger than at least 40 μm.

30. The method of any one of claims 1-24, wherein the LiMnO sorbent is has a particle size distribution wherein >90% of the particles are larger than at least 40 μm.

31. The method of any one of claims 1-24, wherein the LiMnO sorbent is has a particle size distribution wherein >50% of the particles are larger than at least 100 μm.

32. The method of any one of claims 1-24, wherein the LiMnO sorbent is has a particle size distribution wherein >75% of the particles are larger than at least 100 μm.

33. The method of any one of claims 1-24, wherein the LiMnO sorbent is has a particle size distribution wherein >90% of the particles are larger than at least 100 μm.

34. The method of any one of claims 1-24, wherein the LiMnO sorbent has a particle size distribution wherein at least 50% of the particles are less than 75 μm.

35. The method of any one of claims 1-24, wherein the LiMnO sorbent is has a particle size distribution wherein at least 75% of the particles are less than 75 μm.

36. The method of any one of claims 1-24, wherein the LiMnO sorbent is has a particle size distribution wherein at least 90% of the particles are less than 75 μm.

37. The method of any one of claims 34-36, wherein at least 50% of the LiMnO sorbent is about 1.1 μm.

38. The method of any one of claims 1-33, wherein the MPP has a MPS of 0.1-5,000 μm.

39. The method of any one of claims 1-38, wherein the LPP has a MPS of 0.5-500 μm.

40. The method of any one of claims 1-39, comprising milling the PPM.

41. The method of claim 40, wherein the PPM is milled with at least one of a ball mill, planetary ball mill, jet mill, and/or roller mill.

42. A sorbent composition comprising a sorbent having the general formula Li_{1+X}Mn_{2-Y}O₄ where 0.2≤X≤1.7 and 0.2≤Y≤0.7 and the sorbent having a mean particle size (MPS) greater than 1 μm and wherein the sorbent composition is filterable.

43. The sorbent composition of claim 42, wherein the MPS is greater than 10 μm.

44. A sorbent composition comprising a sorbent having the general formula Li_{1+X}Mn_{2-Y}O₄ where 0.2≤X≤1.7 and 0.2≤Y≤0.7, the sorbent having a mean particle size (MPS) greater than 50 μm.

45. The sorbent composition of any one of claims 42-44, wherein the general formula of the sorbent is Li_{1+X}Mn_{2-Y}O₄ where 0.3≤X≤0.6 and 0.3≤Y≤0.4.

46. The sorbent composition of any one of claims 42-45, wherein the sorbent composition has greater than 90% purity of sorbent compound and less than 10% of non-active materials.

47. The sorbent composition of any one of claims 42-45, wherein the sorbent composition has greater than 80% purity of sorbent compound and less than 20% of non-active materials.

48. The sorbent composition of any one of claims 42-45, wherein the sorbent composition has greater than 70% purity of sorbent compound and less than 30% of non-active materials.

49. The sorbent composition of any one of claims 42-48, wherein the sorbent is prepared by the method of any one of claims 1-41.

50. Use of the sorbent composition of any one of claims 42-49 to selectively adsorb lithium from a brine, wherein the sorbent composition is filterable.

51. A method of separating the sorbent of any one of claims 42-49 having a MPS greater than 1 μm from a liquid comprising:
a. introducing a volume of a suspension of a sorbent composition comprising the sorbent and liquid into a separation chamber having a filtration media;
b. applying a vacuum to the filtration media to separate the liquid from the sorbent;
wherein the liquid is separated from the LiMnO at a rate of at least 10 mL liquid/(sec)(m²).

52. The method of claim 51, wherein the liquid is separated from LiMnO at a rate of 10-1500 mL liquid/(sec)(m²).

53. The method of any one of claims 51-52, wherein the sorbent composition is prepared by the method of claim 4.
